(19) United States
(12) Patent Application Publication
(10) Pub. No.: US 2002/0178628 A1
(43) Pub. Date: Dec. 5, 2002

(54) Three-dimensional label for a container and method of forming the same

(76) Inventor: Andre W. Grasso, Garrison, NY (US)

Correspondence Address: ARLEN L. OLSEN, SCHMEISER, OLSEN & WATTS, 3 LEAR JET LANE, SUITE 201, LATHAM, NY, 12110, US

(21) Appl. No.: 10/191,927

(22) Filed: Jul. 9, 2002

Related U.S. Application Data
(62) Division of application No. 09/818,113, filed on Mar. 27, 2001.

(51) Int. Cl. G09F 3/00

(52) U.S. Cl. 40/310

(57) ABSTRACT

A three-dimensional label for a container and a method of forming the label is disclosed. The label includes a first portion flush with a surface of the container, a second portion extending away from the surface of the container, and graphics.

### BACKGROUND OF THE INVENTION

1. Technical Field

The present invention relates generally to labeling, and more particularly, to a method of forming a unique three-dimensional label, and the label so formed.

2. Related Art

Many labels for containers, such as beverage containers, food containers, etc., have been limited to two-dimensional designs. Attempts have been made to create three-dimensional designs formed out of the container itself, such as embossing, casting, and so on. Similarly, containers have been formed, as disclosed in the patents to Haughk et al. (U.S. Pat. Nos. 5,937,554, and 6,073,373), wherein a portion of the label is placed within the container to give the label a three-dimensional effect. However, none have provided a three-dimensional label attachable to the surface of a container.

### SUMMARY OF THE INVENTION

The first general aspect of the present invention provides a three-dimensional label for a container, comprising: a raised portion extending away from a surface of the container; and an adhesive material on a surface of the label attaching the label to the surface of the container.

The second general aspect of the present invention provides a container having a label affixed to a surface of the container, wherein the label includes a three-dimensional design.

The third general aspect of the present invention provides a method of forming a three-dimensional label for a container, comprising: creating an image on a first surface of a flexible material; causing at least a portion of the image to become deformed; and adhering a second surface of the flexible material to a surface of the container.

The foregoing and other features of the invention will be apparent from the following more particular description of the embodiments of the invention.

### BRIEF DESCRIPTION OF THE DRAWINGS

The embodiments of this invention will be described in detail, with reference to the following figures, wherein like designations denote like elements, and wherein:

FIG. 1A depicts a container having a three-dimensional label thereon, in accordance with the present invention;

FIG. 1B depicts a container having a three-dimensional label thereon, in accordance with the present invention;

FIG. 2A depicts the three-dimensional label of FIG. 1A, in accordance with the present invention;

FIG. 2B depicts the three-dimensional label of FIG. 1B, in accordance with the present invention; and

FIG. 3 depicts a cross-sectional view of the container and the three-dimensional label, in accordance with the present invention.

### DESCRIPTION OF THE PREFERRED EMBODIMENTS

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc. Although the drawings are intended to illustrate the present invention, the drawings are not necessarily drawn to scale.

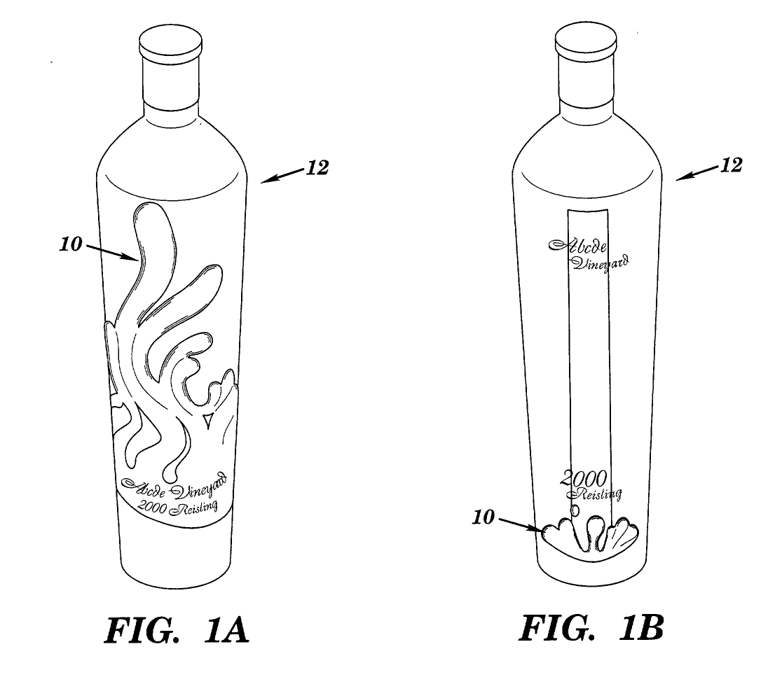

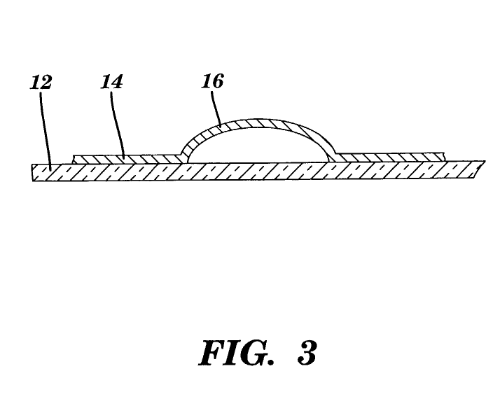

The present invention provides a three-dimensional advertising label 10 on a container 12, similar to the label 10 illustrated in FIGS. 1A and 1B. The container 12 may be a beverage container, such as a wine bottle, as shown in this example, a soda container, a juice container, a container for food products, a container for health and beauty items such as a shampoo container, or a container for pharmaceuticals and so on. As illustrated more clearly in FIG. 3, which shows a cross-sectional view of the label 10 and container 12, the label 10 may comprise a flat portion 14, or a portion laying flush with the surface of the container 12, and a raised or three-dimensional portion 16, or a portion extending outward from the surface of the container 12.

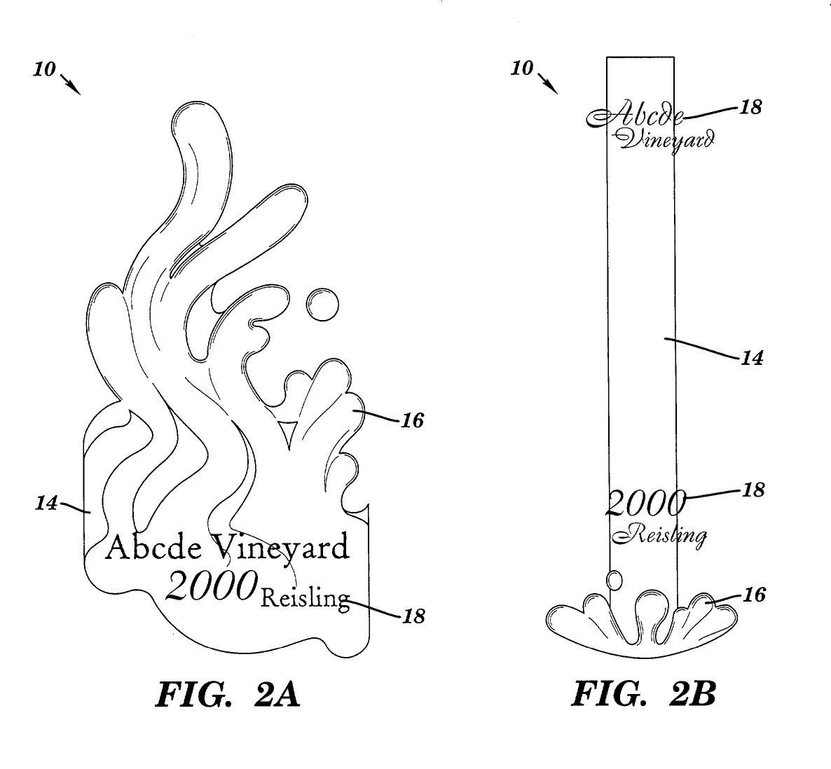

As illustrated in FIGS. 2A and 2B, the label 10 may also comprise graphics 18, such as a company name, the contents of the container 12, a logo, etc. In the examples illustrated herein, the containers 12 are wine bottles. The graphics 18 are printed on the flat portion 14 of the label 10, and the three-dimensional portion 16 takes the form of splashing wine.

The flat portion 14, the three-dimensional portion 16, and the graphics 18 may be formed using various colors. Likewise, the label 10 may take various shapes and sizes, and is in no way limited by the example illustrated herein. The label 10 may cover a portion of the container 12, as shown, or the entire container 12, and may be located on any area of the container 12 desired. Likewise, the label 10 may be formed without the flat portion 14, wherein the graphics 18 are printed within the three-dimensional portion 16. The label 10 may be formed without graphics 18. More than one label 10 may be placed on the container 12, as desired, and so on.

The label 10 may be formed using a process referred to as “distortion printing,” or other similar process. For example, a label form and graphic design template is produced using a combination of solid modeling software, e.g., a pro/ENGINEER™ program, a mechanical desktop program, etc., and graphic and/or illustration software, e.g., 3-D studio™ max/viz, Corel™, etc.

The template is then printed onto the underside of a substantially planar sheet of flexible material, such as a clear PVC, PTEG, or other similar material, to form a printed blank. A screen printing process, offset lithography, flexographic and digital ink jet printing, or other similar process, may be used to print the template image onto the flexible material. Various color inks may be used to print the template onto the material, thereby providing a wide range of flexibility in the design of the finished label 10. Thermoformable inks, such as UV curable inks, may be used as they exhibit the characteristics necessary to withstand the subsequent processing, such as being malleable with the application of heat, resistant to melting and bubbling, flexible, adhesive, etc. Screen printing allows for a large quantity of templates to be formed on a flat sheet of material at one time, thereby reducing the time required to produce the label 10, however, other similar processes may also be used.

An adhesive material, to facilitate adhesion of the label 10 to the container 12, such as a double-faced adhesive sheet is applied to a back surface of the label 10 prior to formation of the three-dimensional form. The three-dimensional image is then formed into the blank using a thermoforming process, or other similar molding processes. For example, the blank is clamped into a thermoforming machine. Within the thermoforming machine the blank is exposed to an array of “zoned” heating elements that bring various portions of the blank to the appropriate temperature levels. Once the blank reaches the appropriate temperature levels, the blank begins to soften. The softened blank is then placed in contact with a molding tool within the thermoforming machine.

It should be noted that the label 10 may be formed using a single tool, or multiple tools, such as ganged tools, etc. For instance, for shallow images a male mold may be used wherein the mold is forced into the blank. For deeper images, a female mold may be used in conjunction with a vacuum forming process to draw the blank into the mold.

The molded label is then cooled, as needed, and removed from the thermoforming machine. When removing the molded label from the machine, there is the risk of ink delamination. This risk may be minimized by adjusting the heating zones within the machine, utilizing a mold-release spray, drying the ink for a longer period of time before attempting removal, etc.

The label 10 is then trimmed, as needed, using a die-cut process, routing process, or other similarly used process. Thereafter, the label 10 is applied to the container 12, either by hand, using an automated device, or other similarly used application process.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

I claim:

1. A three-dimensional label for a container, comprising:
a raised portion extending away from a surface of the container; and
an adhesive material on a surface of the label attaching the label to the surface of the container.

2. The three-dimensional label of claim 1, further comprising a flat portion flush with the surface of the container.

3. The three-dimensional label of claim 1, further comprising graphics.

4. The three-dimensional label of claim 1, wherein the container is a beverage container.

5. The three-dimensional label of claim 1, wherein the container is a wine bottle.

6. A container having a label affixed to a surface of the container, wherein the label includes a three-dimensional design.

7. The container of claim 6, wherein the label further comprising a raised portion extending away from the surface of the container.

8. The container of claim 6, wherein the label further comprising a flat portion flush with a surface of the container.

9. The container of claim 6, wherein the label further comprising an adhesive material on a surface of the label attaching the label to the surface of the container.

10. The container of claim 6, wherein the container is a beverage container.

11. The container of claim 6, wherein the container is a wine bottle.

12. A method of forming a three-dimensional label for a container, comprising:
creating an image on a first surface of a flexible material;
causing at least a portion of the image to become deformed; and
adhering a second surface of the flexible material to a surface of the container.

13. The method of claim 12, wherein forming the image on the first surface of the flexible material further comprises a print screening process.

14. The method of claim 12, wherein causing at least a portion of the image to become deformed further comprises a thermoforming process.

15. The method of claim 14, wherein the thermoforming process is followed by a cooling process.

16. The method of claim 12, further comprising trimming excess flexible material from the label before adhering the label to the container.
